(19) United States
(12) Patent Application Publication
(10) Pub. No.: US 2020/0201609 A1
(43) Pub. Date: Jun. 25, 2020

(54) Metadata-Driven Design-Time Tooling

(71) Applicant: SAP SE, Walldorf (DE)

(72) Inventors: Martin Schaus, Nussloch (DE); Ioannis Grammatikakis, Maxdorf (DE); Stefan Schreck, St. Leon-Rot (DE); Sebastian Wennemers, Mannheim (DE); Tzanko Stefanov, Karlsruhe (DE); Christoph Gollmick, Heidelberg (DE); Mikhail Benderskiy, Walldorf (DE)

(21) Appl. No.: 16/226,752

(22) Filed: Dec. 20, 2018

(51) Int. Cl. G06F 8/38; G06F 8/34; G06F 8/33; G06F 16/908; G06F 17/22

(52) U.S. Cl. CPC G06F 8/38; G06F 8/34; G06F 17/2247; G06F 16/908; G06F 8/33

(57) ABSTRACT

Disclosed herein are system, method, and computer program product embodiments for using design-time metadata to dynamically determine properties and actions for user-interface elements. By dynamically determining the properties and actions using the design-time metadata, a design-time tool may remain generic and need not include actual change handlers to process the actions and change the properties. By maintaining its agnosticism, a design-time tool may incorporate any changes to an overarching application framework without requiring code updates to the design-time tool itself.

### BACKGROUND

Developers may leverage a development framework to design, implement, and release software applications. Such a development framework may provide core and runtime services, house back-end data, and furnish editing tools that may be used by developers in the creation, management, and deployment of the software applications. The development framework may maintain standardized user-interface components to deploy in the software applications.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 is a block diagram of a user experience framework, according to some embodiments.

FIG. 2 is an example screen display of an editing tool in a user experience framework, according to some embodiments.

FIG. 3 is a flowchart illustrating a method of starting an editing tool in a user experience framework using design-time metadata, according to some embodiments.

FIG. 4 is a flowchart illustrating a method of processing a selection of a user-interface element in an editing tool using design-time metadata, according to some embodiments.

FIG. 5 is a flowchart illustrating a method of changing a property of a user-interface element in an editing tool using design-time metadata, according to some embodiments.

FIG. 6 is a flowchart illustrating a method of processing an action for a selected user-interface element in an editing tool using design-time metadata, according to some embodiments.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for using design-time metadata to dynamically determine properties and actions available for user-interface elements.

A development framework may provide various applications, facilities, and tools to developers to design, implement, modify, maintain, test, and deploy various software applications. For example, the development framework may provide code editors, build tools, debuggers, testing components, and runtime engines. In some embodiments, the development framework may include a version control system, lifecycle management tools, or other means of managing code and controlling releases. The development framework may include object browsers, editors, and other applications integral in the software development process.

Software applications created within a development framework may be web-based applications or delivered to end users in any another suitable fashion. Such software applications may span multitudinous services and industries. For example, and without limitation, software applications may include customer relationship management tools, enterprise resource planning tools, word processing applications, communication applications, product lifecycle management tools, supply chain management, general business solutions, and many other types of applications. The software applications may not be limited only to business needs, and individuals may use the applications for entertainment, personal, financial, or any other appropriate purposes.

A development framework may provide a design-time tool that allows developers to architect, design, and implement software applications. Such a design-time tool may facilitate the creation of a user interface with little-to-no code writing by harnessing model definitions and business logic. Such a design-time tool may include a visual editor that allows the designer to arrange user-interface elements visually. In one embodiment, the design-time tool may be a what-you-see-is-what-you-get (WYSIWYG) editor that allows developers to manipulate user-interface components and other elements directly in the visual editor while translating the layout into executable or otherwise deployable code, i.e., a developer may view the ultimate behavior of the software application simultaneously while designing the software application.

The user-interface elements provided by the development framework may be functional, non-functional, input-based, display-based, contextual, etc., for example, HTML constructs and combinations such as menus, panels, toolbars, layouts, grids, lists, tables, rows, and columns, message boxes, calendars and date fields, sliders, buttons, sections, edit fields, text areas, and many others. A development framework may apply themes, styles, etc. across the user-interface elements. Thus, software applications may be crafted that provide a consistent user experience and usage pattern across disparate software applications. The user-interface elements may adhere to appropriate standards, provide various viewing formations (e.g., XML, HTML, Javascript, JSON, etc.), and may support binding with OData, JSON, and other data formats. As will be discussed in further detail below, the expanse of user-interface elements is vast and varies across software applications.

User-interface elements may also be imbued with certain properties, i.e., editable and customizable information associated with a particular, deployed user-interface element. To provide a simple example, a user-interface element for an editable field may include a property of “Label.” An original “Label” value may be defined by the data model and can be consumed by the user interface or the development framework using an OData service or other web service or protocol. In an embodiment, a user-interface developer may redefine a particular value for the “Label” property to be stored within the development framework. However, a particular user-interface element may include certain properties unique to that particular user-interface element, and the properties may vary from user-interface element to user-interface element and among software applications.

Likewise, the user-interface elements may also carry or be associated with performable actions, i.e., functional behaviors that may be performed when a user engages with the user-interface element. When an action is selected, the development framework may trigger a change handler that processes the selected action. For a simple example, the header of a table may include a “Sort” action. When this action is selected by a user, the rows of the table may be sorted by the field. Such a “Sort” action may not be applicable or available to another user-interface element, e.g. a data field or a section. One skilled in the relevant art(s) will appreciate that the range of user-interface elements that may be included in a software application is vast, and the properties and actions associated with these user-interface elements differs.

As a user experience framework develops and deploys new functionalities, the types of available user-interface elements change along with the actions and properties associated with the user-interface elements. Existing approaches to providing developer frameworks insufficiently accommodate such enhancements. Thus, design-time tools typically have short lifespans because a change to the functionalities of the development framework may invalidate the capabilities performed by the design-time tool, absent further changes being made to the design-time tool itself.

Accordingly, a need exists to allow a client application to use design-time metadata to dynamically determine properties and actions associated with user-interface elements in an agnostic fashion. This supports enhanced or even maximum utilization of user-interface elements in any design-time tool generically without mandating an intrinsic understanding of the properties and actions of the user-interface elements.

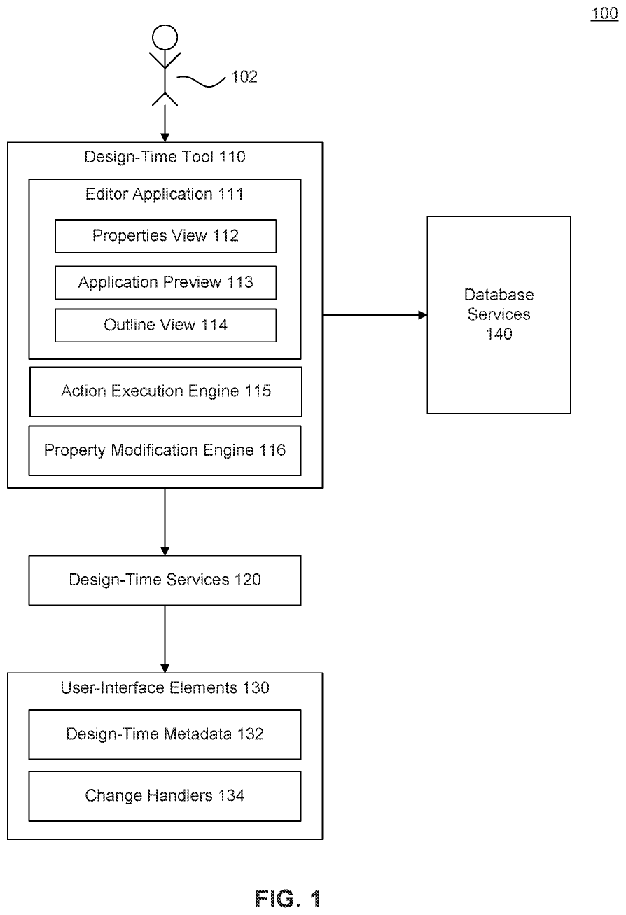

FIG. 1 is a block diagram illustrating user experience framework 100, according to some embodiments. Any operation herein may be performed by any type of structure in the diagram, such as a module or dedicated device, in hardware, software, or any combination thereof. Any block in the block diagram of FIG. 1 may be regarded as a module, apparatus, dedicated device, general-purpose processor, engine, state machine, application, functional element, or related technology capable of and configured to perform its corresponding operation(s) described herein. User experience framework 100 may include user 102, design-time tool 110, design-time services 120, user-interface elements 130, and database services 140.

User 102 may be a developer or other individual designing, developing, and deploying software applications within user experience framework 100. User 102 may be a member of a business, organization, or other suitable group using software designed to perform organizational tasks. User 102 may be a human being, but user 102 may also be an artificial intelligence construct. User 102 may employ, i.e., connect to, a network or combination of networks including the Internet, a local area network (LAN), a wide area network (WAN), a wireless network, a cellular network, or various other types of networks as would be appreciated by a person of ordinary skill in the art.

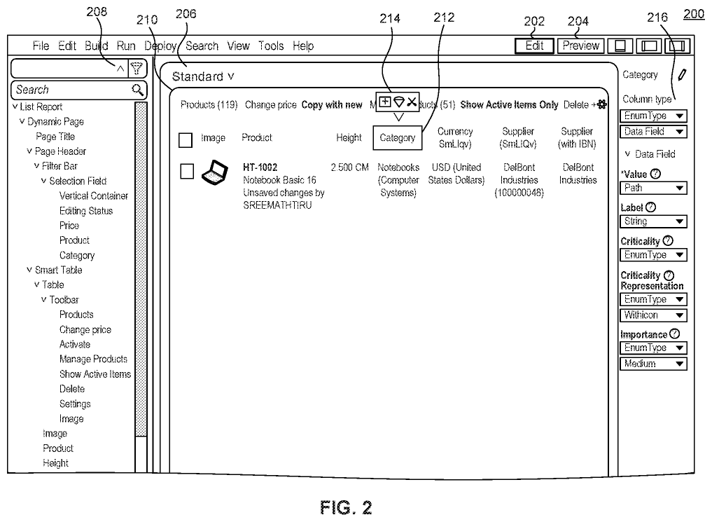

Design-time tool 110 may be employed by user experience framework 100 to allow user 102 to develop software applications in a streamlined fashion. In one embodiment, design-time tool 110 may be a WYSIWYG visual editor that allows user 102 to arrange various user-interface elements via a design interface. In such a tool, user 102 may view the software application as it will be viewed by end-users while simultaneously architecting the software application. However, design-time tool 110 is not limited to a visual editor and may be any suitable tool used by user experience framework 100 to design and/or interact with software applications. Design-time tool 110 may include editor application 111, properties view 112, application preview 113, outline view 114, action execution engine 115, and property modification engine 116. An exemplary illustration of design-time tool 110 is discussed in further detail below with reference to FIG. 2.

Editor application 111 may allow user 102 to deploy and arrange interface components. Editor application 111 may allow user 102 to insert user-interface elements and arrange the user-interface elements to design an appropriate layout. Editor application 111 may include various toolbars and menus to facilitate the insertion and arranging of the user-interface elements. Editor application 111 may allow a developer to customize user-interface elements in a myriad of ways. Editor application 111 may allow developers to integrate data from databases and other backend systems.

Properties view 112 may allow user 102 to view properties for a user-interface element selected in editor application 111 and/or application preview 113. Properties view 112 may allow user 102 to view the current values for the properties associated with the selected user-interface element. Properties view 112 may further allow user 102 to edit the values for properties associated with the selected user-interface element.

Application preview 113 may allow user 102 to preview the software application as the software application will be experienced by an end user. In an embodiment, application preview 113 may provide various browser modes to allow the developer to test the deployed software application across different web browsers. Application preview 113 may allow the developer to view the application in a mobile-mode and/or configured the screen size of a device viewing the software application to ensure that the layout translates across browsers and between devices.

Outline view 114 may allow user 102 to view a hierarchical overview of the currently active software application. Outline view 114 may include all data sources within user experience framework 100 as well as any user-interface elements, described below as user-interface elements 130. In one embodiment, outline view 114 may present a series of folders, with each folder representing a user-interface element. In another embodiment, the folders may be divided into appropriate categories and subcategories.

Action execution engine 115 may process actions selected or otherwise triggered by user 102 on user-interface elements in editor application 111 and/or application preview 113. Action execution engine 115 may interface with design-time services 120 to execute an appropriate change handler in user experience framework 100 or otherwise facilitate appropriate changes within design-time tool 110 based on the actions. Action execution engine 115 may receive responses from design-time services 120 and render the changes in appropriate fashion in design-time tool 110.

Property modification engine 116 may facilitate the retrieval and modification of properties for user-interface components selected by user 102 in editor application 111 and/or application preview 113. Property modification engine 116 may use design-time services 120 to change the properties and to update the view in design-time tool 110 for the developer as properties change. Property modification engine 116 may interact with database services 140 to ensure that changed properties are stored in user experience framework 100 for later retrieval. Property modification engine 116 may receive responses from design-time services 120 about the available properties and the values of the properties as well as changes to the properties and render the changes in appropriate fashion in design-time tool 110.

Design-time services 120 may address, perform, and/or execute behaviors conducted by developers, i.e. user 102, while using design-time tool 110. Design-time services 120 may process creating, building, deleting, and updating of software applications in a myriad of fashions. For example, design-time services 120 may handle the insertion of a user-interface component into software applications or process the deletion of such user-interface component. Design-time services 120 may facilitate the modification or rearranging of the user-interface components through the provisioning of drag-and-drop interface. Design-time services may interact with action execution engine 115 and property modification engine 116 to process actions performed within design-time tool 110 and to change properties and render the changes in editor application 111 and/or application preview 113. Design-time services 120 may perform a litany of other actions.

User-interface elements 130 may include design-time metadata 132 and change handlers 134. User-interface elements 130 may be a wide-array of visual, functional, or other elements deployable within design-time tool 110 to be embedded in a software application. Just for example, user-interface elements 130 may include HTML elements or combinations thereof such as: menus, panels, toolbars, layouts, grids, lists, tables, rows, and columns, message boxes, calendars and date fields, sliders, buttons, sections, edit fields, text areas, and many others. User experience framework 100 may apply themes, styles, CSS, etc. across the provided user-interface elements wherever used in the framework. Through this standardization, software applications may be crafted that provide a consistent user experience and patterns across disparate software applications. The user-interface elements may adhere to coding standards, provide various viewing formations (e.g., XML, HTML, Javascript, JSON, etc.), and may support binding with OData, JSON, and other data formats.

User-interface elements 130 may also include certain properties and actions. Properties may be editable and customizable information associated with a particular deployed user-interface element. Actions may be functional behaviors that may be performed when users engage with the user-interface element.

Design-time metadata 132 may allow design-time tool 110 to support user-interface changes to a developer framework without updating the code for the design-time tool. Design-time metadata 132 is associated with a user-interface element, such as user-interface elements 130. Design-time metadata 132 describes the properties of each user-interface element that may be changed by user 102 and any actions that may be executed by user 102 when interacting with the user-interface element in design-time tool 110. Design-time metadata 132 may specify a linkage between a user-interface-element-associated object and an associated change handler, described below as change handlers 134. Additional generic constructs may be provided by user experience framework 100 to allow the consumption of design-time metadata 132 by design-time tool 110. In an alternative embodiment, any other implement using the user-interface elements may harness design-time metadata 132 to receive perform actions and view properties of the user-interface elements without development efforts. In other words, the use of design-time metadata 132 is not limited to a design-time tool, and design-time metadata 132 may be used by runtime engine and in a wide-array of other capacities.

Design-time metadata 132 may be specified using human-readable, machine-interpretable text. As one skilled in the arts will appreciate, such human-readable, machine-interpretable text can be achieved using JSON strings, XML, or other appropriate text-based format. Design-time metadata 132 may also be specified using any other suitable method that defines a linkage between user-interface elements and the actions and properties associated with those user-interface elements. An example of design-time metadata is provided here, however, this is merely exemplary:

dateFieldForAction: {

namespace: “com.sap.vocabularies.UI.v1”,
annotation: “DataFieldForAction”,
whitelist: {
properties: {

[“Action”, “Label”, “Criticality”, “InvocationGrouping”]
},

actions: {

remove: {changeType: “removeTableColumn”}
reveal: {changeType: “revealTableColumn”}}
},

}

In this merely exemplary illustration, the whitelist field provides the properties that are available for the particular user-interface element while the actions field provides the actions that are available for a user when the user-interface element is selected. The properties included in this exemplary embodiment need not provide more detailed descriptions as the properties reference property definitions in OData vocabularies or other API namespaces. However, in other embodiment, additional details may be provided.

Design-time metadata 132 allows design-time tool 110 to have a different lifecycle from user-interface elements 130. User experience framework 100 may define new capabilities in design-time metadata 132 and change handlers 134 without requiring an update to the editor, i.e., design-time tool 110, in order to harness the new capabilities.

Change handlers 134 may be deployed by user experience framework 100 to process actions available to user-interface elements 130. Change handlers 134 may be bound to an event object or other object to ensure that the appropriate action is completed when the action is received in design-time tool 110. One skilled in the relevant arts will appreciate that change handlers 134 may correspond to the available actions stored in design-time metadata 132. Change handlers 134 may be completed and stored within user experience framework 100 using any suitable functional, object-oriented, or other programming language.

Database services 140 may be a variety of storage capabilities and associated operations leveraged, harnessed, or otherwise available within user experience framework 100. Database services 140 may be cloud-based or database services 140 may be a relational database harnessing any commercially available database management system such as SAP HANA, SAP IQ, Microsoft Access, Microsoft SQL server, an Oracle database, an IBM database, etc. In an embodiment, database services 140 implement a centralized storage area network (SAN), network-attached storage (NAS), redundant array of independent disks, and/or any other configuration of storage devices to supply sufficient storage capacity to store the needed database tables and supporting structures. Sufficient storage alternatively exists in any other physically attached magnetic storage, cloud storage, or additional storage medium. In an embodiment, database services 140 deploys a commonly utilized hard-disk interface, such as ATA, SATA, SCSI, SAS, and/or fibre for interfacing with any storage mediums.

FIG. 2 is an example screen display 200 of an editing tool, such as design-time tool 110, in a user experience framework, according to some embodiments. Screen display 200 is merely exemplary, and one skilled in the relevant art(s) will appreciate that many approaches may be taken to provide a suitable screen display 200 in accordance with this disclosure. Screen display 200 may include: switch-to-edit-view button 202, switch-to-preview-view button 204, edit window 206, section selector 208, section 210, selected element 212, actions 214, and properties 216.

Switch-to-edit-view button 202 may provide a developer, such as user 102, an editing window in which the user may arrange user-interface elements and configure advanced properties a software application. In an embodiment, switch-to-edit-view button 202 may be the default view for user 102 upon initiating design-time tool 110 and loading an existing or creating a new software application.

Switch-to-preview-view button 204 may be clicked by user 102 to view the software application as processed by a runtime engine. In other words, clicking switch-to-preview-view button 204 may allow a developer to experience the application being developed from the perspective of an end user. In an embodiment, the preview mode and the edit mode may be toggled between and/or switched to/from by clicking switch-to-edit-view button 202 or switch-to-preview-view button 204.

Edit window 206 may be a portion of the screen in which a user may insert user-interface elements and arrange the user-interface elements spatially on the screen. The example provided in screen display 200 is a WYSIWYG editor, however, this is merely illustrative.

Section selector 208 may include applications used by or contained in the integrated development environment. Section selector 208 may be displayed hierarchically and may be searchable. In one example, when user 102 selects a particular application, an editing window may be displayed in which user 102 may edit the application. In another embodiment, section selector 208 may display an outline of user-interface elements in the application, and the description of the element may be based on design-time metadata 132.

Section 210 is just one example of a user-interface element. Section 210 includes a variety of other user-interface elements, e.g., a table. That table in turn includes additional user-interface elements including rows, columns, headers, etc. In the exemplary embodiment displayed in FIG. 2, the software application displays a “Product” in a table along with details about that “Product.”

Selected element 212 is a user-interface element in edit window 206 that is selected by user 102. User 102 may select an element using a mouse-click, keyboard instruction, swipe, or any other suitable input mechanism. In the exemplary embodiment displayed in FIG. 2, user 102 selected “Category,” a column header.

Actions 214 display when user 102 selects selected element 212. The nature of actions 214 will vary depending on selected element 212. For example, user 102 may select two column headers using a suitable input mechanism. When more than one user-interface element is selected, additional actions may be displayed in actions 214, for example, the ability to merge the two selected user-interface elements. In the exemplary embodiment displayed in FIG. 2, actions 214 include the ability to add, edit, and delete the information in selected element 212. In some embodiments, more than one user-interface element may be selected as selected element 212.

Properties 216 display when user 102 selects selected element 212. The properties that display in properties 216 may vary based upon the nature of the user-interface element that is selected. In the exemplary embodiment displayed in FIG. 2, the properties include for selected element 212 include “Label,” “Criticality,” “Criticality Representation,” and “Importance.”

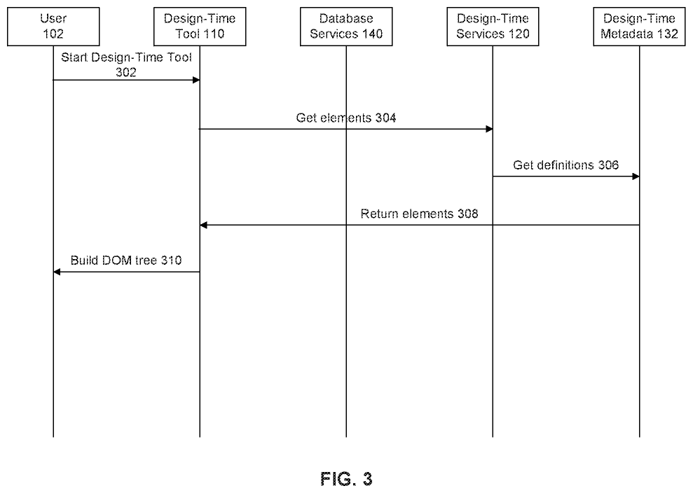

FIG. 3 illustrates a method 300 of starting an editing tool in a user experience framework using design-time metadata, according to some embodiments. Method 300 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art(s).

In 302, design-time tool 110 may be loaded, initiated, commenced, launched, or otherwise started by user 102 in any suitable fashion. In an embodiment, user 102 may initiate design-time tool 110 from a launch-pad or other location within user experience framework 100. In an alternate embodiment, design-time tool 110 may be started automatically or based on any appropriate triggering condition. Design-time tool 110 may load a preview of the software application viewing by user 102. Design-time tool 110 may retrieve and render features for manipulating the software application, for example edit window 206, section selector 208, toolbars, menus, or any other supporting tools used within design-time tool 110. Design-time tool 110 may also download/retrieve client-side code such as change handlers 134 needed to generalize the execution of various components once loading is complete.

In 304, design-time tool 110 may engage design-time services 120 to retrieve user-interface elements, such as user-interface elements 130, to display in switch-to-edit-view button 202 or switch-to-preview-view button 204. Design-time tool 110 may communicate the request using an appropriate function, communication protocol, application programming interface, etc.

In 306, design-time services 120 may retrieve the definitions from design-time metadata 132. The definitions may include information about a variety of deployed user-interface elements including: menus, panels, toolbars, layouts, grids, lists, tables, rows, and columns, message boxes, calendars and date fields, sliders, buttons, sections, edit fields, text areas, etc. Design-time services 120 may retrieve location information and position the elements appropriately in edit window 206. Design-time services 120 may retrieve properties and actions associated with the user-interface element. Moreover, design-time services 120 may determine if a user-interface element is selectable. For instance, a user-interface element may not be selected when no active properties or actions are specified in design-time metadata 132 for that user-interface element.

In 308, design-time services 120 may return the elements, properties, and actions to the design-time tool 110. Design-time services 120 may communicate the information to design-time tool 110 using any suitable communication protocol.

In 310, design-time tool 110 may build a DOM tree that includes all of the user-interface elements, as well as the associated properties and actions. The DOM tree may be a tree structure representing the software application using a logical tree. The DOM tree may only include the manipulable user-interface elements, i.e., those with active properties and actions specified in the design-time metadata. In this fashion, the software application may be rendered with those fields without associated actions or properties being grayed out or hidden so that a user may not be able to select user-interface elements that cannot be acted upon.

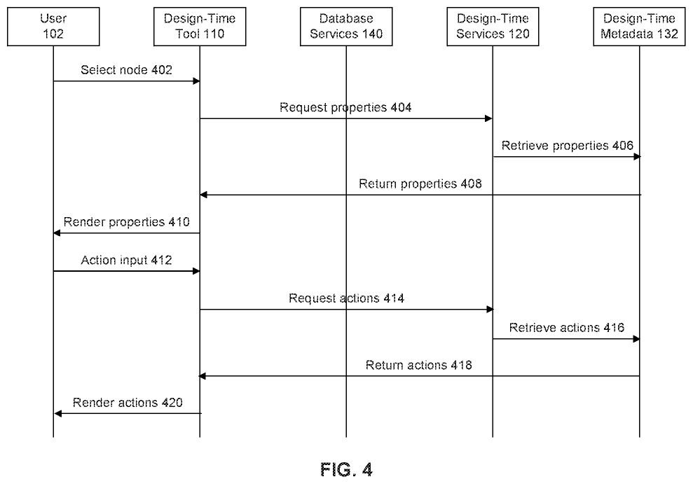

FIG. 4 illustrates a method 400 for processing a selection of a user interface element in an editing tool using design-time metadata, according to some embodiments. Method 400 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art(s).

In 402, user 102 selects a user-interface element displayed in design-time tool 110. In an embodiment, user 102 may select the user-interface element in editor application 111, application preview 113, or in a DOM tree displayed in another suitable location. Design-time tool 110 may trigger an event noting that a user-interface element was selected by user 102 to trigger appropriate reactions and/or binding events.

In 404, design-time tool 110 requests properties for the selected user-interface element. Design-time tool 110 may call a core service of design-time services 120 to fetch all property information from the design-time metadata. Design-time tool 110 may communicate the request using an appropriate function, communication protocol, application programming interface, etc.

In 406, design-time services 120 may retrieve the properties from design-time metadata 132. The properties may include specified name and value pairs or any other method of determining the properties associated with the selected user-interface element.

In 408, design-time services 120 returns the retrieved properties to design-time tool 110. The response may include the metadata of all relevant artifact types as well as the current values of each fetched property.

In 410, design-time tool 110 renders the retrieved properties. Design-time tool 110 may render the retrieved properties view 112, described in FIG. 2 as properties 216. The properties and their values may be rendered in a fashion that dynamically renders all retrieved properties. In an embodiment, properties view 112 may dynamically decide on an appropriate control to render based on a retrieved data type. Thus, the behavior of design-time tool 110 may be dynamically controlled based solely on the retrieved design-time metadata.

In 412, user 102 enters an input to retrieve the actions that are available with a selected user-interface elements. in design-time tool 110. In an embodiment, user 102 may first select a user-interface element in editor application 111, application preview 113, or in a DOM tree displayed in another suitable location and then right-click, enter a key, swipe appropriately or perform another suitable indication that the actions associated with the selected user-interface element should be retrieved. Design-time tool 110 may trigger an event noting that the action was received from user 102.

In 414, design-time tool 110 requests the actions for the selected user-interface element. Design-time tool 110 may call a core service of design-time services 120 to fetch all actions from design-time metadata 132. Design-time tool 110 may communicate the request using an appropriate function, communication protocol, application programming interface, etc.

In 416, design-time services 120 may retrieve the actions from design-time metadata 132. The actions may be retrieved in JSON, XML, or other human or machine readable text. The actions may specify change handlers associated with the action to be called within user experience framework 100. Design-time metadata 132 may further specify parameters to be included in function calls associated with the action if ultimately performed.

In 418, design-time services 120 returns the retrieved actions to design-time tool 110. The response may include the metadata of all relevant artifact types, any retrieved actions, and associated parameters.

In 420, design-time tool 110 renders the retrieved actions. Design-time tool 110 may render the actions within a construct such as actions 214, described in FIG. 2. The actions may be relayed textually, using images, or via any appropriate method. Thus, the actions performable by design-time tool 110 may be controlled solely by updating the design-time metadata and change handlers within the framework.

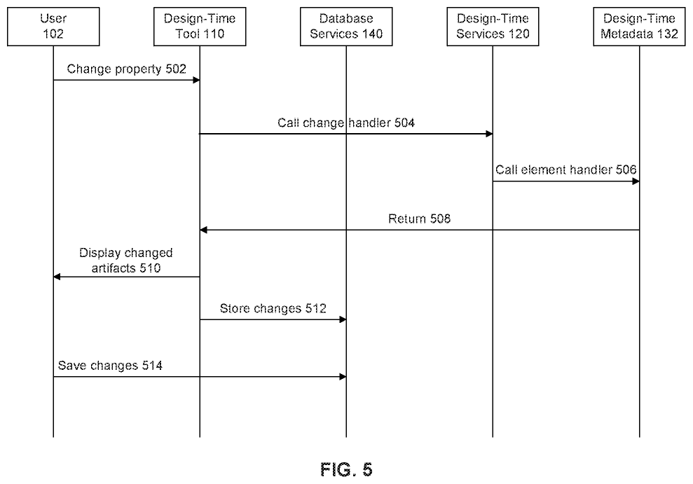

FIG. 5 is a flowchart illustrating a method 500 of changing a property of a user interface element in an editing tool using design-time metadata, according to some embodiments. Method 500 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art(s).

In 502, user 102 changes the value of a property in design-time tool 110. For example, user 102 may change the displayed value in properties view 112, described in FIG. 2 as properties 216. The value may be a text field, integer, date, or any other suitable input field.

In 504, design-time tool 110 calls an appropriate change handler from among change handlers 134 based on the property changed in 502. Certain properties may be generically handled using a generic change handler. However, other properties may require an element-specific change handler. Thus, design-time tool 110 may determine if an element-specific change handler is needed.

In 506, design-time services 120 calls an element specific handler from design-time metadata 132 to process the changed property.

In 508, design-time services 120 may return appropriate information to design-time tool 110. This may include an indicator of success and further include elements, properties, actions, values, etc. Design-time services 120 may communicate the information to design-time tool 110 using any suitable communication protocol.

In 510, design-time tool 110 may display changed artifacts for user 102. Design-time tool 110 may render the changed artifacts in editor application 111, application preview 113, or other application making use of the design-time metadata. For example, if user 102 changes the “Label” property of the “Header” of a table, design-time tool 110 may re-render the table with the new “Label” displaying.

In 512, design-time tool 110 may engage database services 140 to store the changed property information. Such property information may persist outside the software application or design-time tool 110.

In 514, user 102 may save the changed property information via a user action. Thus, the storing of changed property information may be triggered by a user action or implicitly by design-time tool 110, as described in 512.

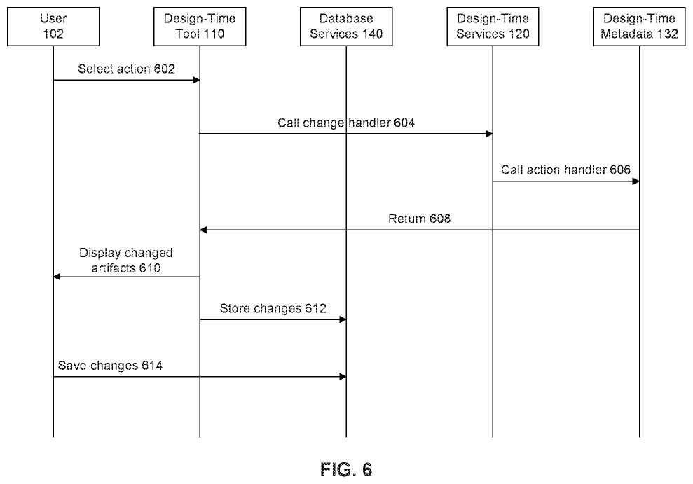

FIG. 6 is a flowchart illustrating a method 600 of processing an action for a selected user-interface element in an editing tool using design-time metadata, according to some embodiments. Method 600 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art(s).

In 602, user 102 selects an action associated with a user-interface element in design-time tool 110. For example, user 102 may select a merge operation for two selected data fields in actions 214. This action is merely illustrative, however, and a wide-array of functionalities may be included and performed.

In 604, design-time tool 110 calls an appropriate change handler from among change handlers 134 based on the action selected in 602. Certain actions may be generically handled using a generic change handler. However, other actions may require an element-specific change handler.

In 606, design-time services 120 calls an element specific handler, if needed, from design-time metadata 132 to perform the action selected in 602.

In 608, design-time services 120 may return appropriate information to design-time tool 110. This may include confirmation that the action was processed correctly and further include elements, properties, actions, values, etc. Design-time services 120 may communicate the information to design-time tool 110 using any suitable communication protocol.

In 610, design-time tool 110 may display changed artifacts for user 102. Design-time tool 110 may render the changed artifacts in editor application 111, application preview 113, or other application making use of the design-time metadata. For example, if user 102 merges the two data fields, design-time tool 110 may display the merged fields in editor application 111, application preview 113, or other suitable location.

In 612, user 102 may save the changed property information via a user action. Thus, the storing of changed property information may be triggered by a user action or implicitly by design-time tool 110, as described in 610.

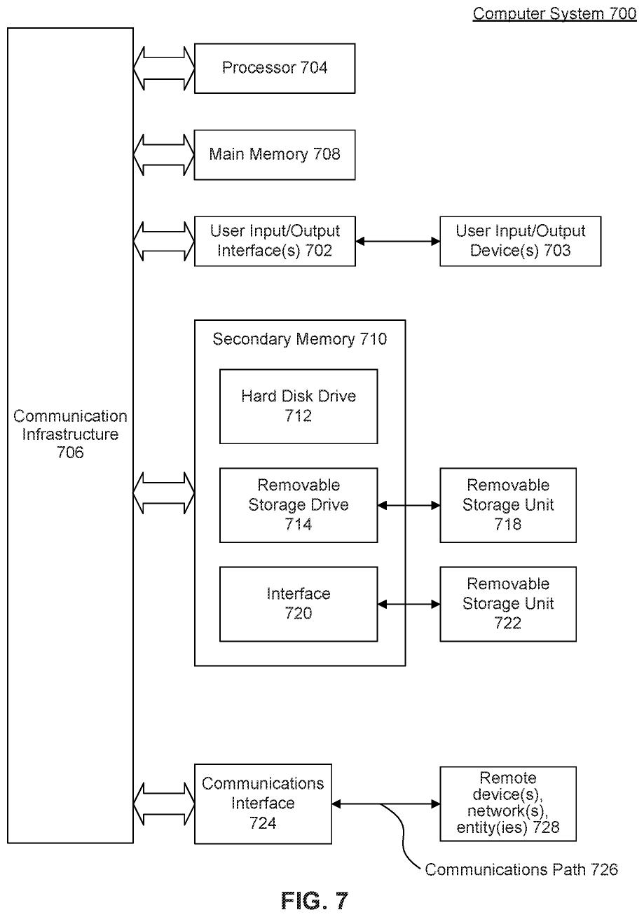

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 708, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
storing, by a user experience framework, design-time metadata associated with user-interface elements, wherein the design-time metadata describes modifiable properties of the user-interface elements and performable actions of the user-interface elements;
rendering, by the user experience framework, the user-interface elements in a design-time tool;
determining, by the user experience framework, a selected user-interface element from among the user-interface elements;
retrieving, by the user experience framework, the design-time metadata associated with the selected user-interface element;
determining, by the user experience framework, at least one action and at least one property for the selected user-interface element based on the retrieved design-time metadata; and
displaying, by the user experience framework, the at least one action and the at least one property in the design-time tool in association with the selected user-interface element,
wherein at least one of the storing, rendering, determining, retrieving, and displaying are performed by one or more computers.

2. The method of claim 1, further comprising:
associating, by the user experience framework, the performable actions with change handlers;
receiving, by the user experience framework, a selected action from among the at least one action; and
executing, by the user experience framework, the change handler from the change handlers associated with the selected action.

3. The method of claim 1, further comprising:
receiving, by the user experience framework, an update to a property from among the at least one property;
applying, by the user experience framework, the update to the property; and
redisplaying, by the user experience framework, the selected-user interface element based on the update.

4. The method of claim 1, further comprising:
determining, by the user experience framework, that the selected user-interface element is not associated with the design-time metadata; and
displaying, by the user experience framework, a visual indicator in the design-time tool in association with the selected user-interface element indicating that no actions are performable.

5. The method of claim 1, wherein the user interface elements are HTML elements.

6. The method of claim 1, wherein the design-time metadata further comprises visual indicators associated with the user-interface elements, the modifiable properties, and the performable actions.

7. The method of claim 1, wherein the design-time tool is a what-you-see-is-what-you-get editor.

8. A system, comprising:
a memory; and
at least one processor coupled to the memory and configured to:
store design-time metadata associated with user-interface elements in a user experience framework, wherein the design-time metadata describes modifiable properties of the user-interface elements and performable actions of the user-interface elements;
render the user-interface elements in a design-time tool;
determine a selected user-interface element from among the user-interface elements;
retrieve the design-time metadata associated with the selected user-interface element;
determine at least one action and at least one property for the selected user-interface element based on the retrieved design-time metadata; and
display the at least one action and the at least one property in the design-time tool in association with the selected user-interface element.

9. The system of claim 8, the at least one processor further configured to:
associate the performable actions with change handlers;
receive a selected action from among the at least one action; and
execute the change handler from the change handlers associated with the selected action.

10. The system of claim 8, the at least one processor further configured to:
receive an update to a property from among the at least one property;
apply the update to the property; and
redisplay the selected-user interface element based on the update.

11. The system of claim 8, the at least one processor further configured to:
determine that the selected user-interface element is not associated with the design-time metadata; and
display a visual indicator in the design-time tool in association with the selected user-interface element indicating that no actions are performable.

12. The system of claim 8, wherein the user interface elements are HTML elements.

13. The system of claim 8, wherein the design-time metadata further comprises visual indicators associated with the user-interface elements, the modifiable properties, and the performable actions.

14. The system of claim 8, wherein the design-time tool is a what-you-see-is-what-you-get editor.

15. A non-transitory computer-readable device having instructions stored thereon that, when executed by at least one computing device, cause the at least one computing device to perform operations comprising:
storing, by a user experience framework, design-time metadata associated with user-interface elements, wherein the design-time metadata describes modifiable properties of the user-interface elements and performable actions of the user-interface elements;
rendering, by the user experience framework, the user-interface elements in a design-time tool;
determining, by the user experience framework, a selected user-interface element from among the user-interface elements;
retrieving, by the user experience framework, the design-time metadata associated with the selected user-interface element;
determining, by the user experience framework, at least one action and at least one property for the selected user-interface element based on the retrieved design-time metadata; and
displaying, by the user experience framework, the at least one action and the at least one property in the design-time tool in association with the selected user-interface element.

16. The non-transitory computer-readable device of claim 15, the operations further comprising:
associating, by the user experience framework, the performable actions with change handlers;
receiving, by the user experience framework, a selected action from among the at least one action; and
executing, by the user experience framework, the change handler from the change handlers associated with the selected action.

17. The non-transitory computer-readable device of claim 15, the operations further comprising:
receiving, by the user experience framework, an update to a property from among the at least one property;
applying, by the user experience framework, the update to the property; and
redisplaying, by the user experience framework, the selected-user interface element based on the update.

18. The non-transitory computer-readable device of claim 15, the operations further comprising:
determining, by the user experience framework, that the selected user-interface element is not associated with the design-time metadata; and
displaying, by the user experience framework, a visual indicator in the design-time tool in association with the selected user-interface element indicating that no actions are performable.

19. The non-transitory computer-readable device of claim 15, wherein the design-time metadata further comprises visual indicators associated with the user-interface elements, the modifiable properties, and the performable actions.

20. The non-transitory computer-readable device of claim 15, wherein the design-time tool is a what-you-see-is-what-you-get editor.
